(19) United States
(12) Patent Application Publication
(10) Pub. No.: US 2015/0242988 A1
(43) Pub. Date: Aug. 27, 2015

(54) METHODS OF ELIMINATING REDUNDANT RENDERING OF FRAMES

(71) Applicant: Nvidia Corporation, Santa Clara, CA (US)

(72) Inventors: Jeffrey Bolz, Austin, TX (US); Xinheng Li, Santa Clara, CA (US); Eric Lum, Santa Clara, CA (US); Emmett Kilgariff, Santa Clara, CA (US)

(21) Appl. No.: 14/627,496

(22) Filed: Feb. 20, 2015

Related U.S. Application Data
(60) Provisional application No. 61/943,335, filed on Feb. 22, 2014.

(51) Int. Cl. G06T 1/20; G06T 3/40; G06T 11/60

(52) U.S. Cl. CPC G06T 1/20; G06T 11/60; G06T 3/4038; G06T 2210/12; G06T 2207/20021; G06T 2210/22

(57) ABSTRACT

A method for reducing redundant rendering of frames includes receiving draw calls including state information for a frame. The method includes generating respective bounding boxes for the draw calls. The bounding box is generated based on vertex data, vertex programs and transformation matrices. The method includes comparing the draw calls of the frame to the draw calls of one or more previous frames and identifying draw calls that are not identical in the compared frames. The method includes identifying the bounding boxes containing altered regions of the frames based on the draw calls that are not identical in the compared frames. The method includes reducing the altered regions into a smaller set of clip rectangles and rendering only inside the clip rectangles.

### CROSS REFERENCE TO RELATED APPLICATION

This application relates to and claims priority from U.S. Provisional Patent Application No. 61/943,335, entitled “Method for Detecting and Eliminating Redundant Rendering” filed Feb. 22, 2014, and incorporated herein by reference.

### TECHNICAL FIELD

The present disclosure is directed, in general, to methods of eliminating redundant rendering of frames.

### BACKGROUND

Many graphical applications running on mobile devices generate frames that have significant frame-to-frame redundancies. For example, many two-dimensional games have a static background and a user interface that rarely change from a frame to a next frame, and furthermore have only a small number of animated objects that change every frame. These graphical applications render through OpenGL, and re-render an entire buffer including all static objects for each frame. It will be appreciated that rendering of static objects that do not change frame-to-frame results in unnecessary utilization of a central processing unit (CPU) or a graphics processing unit (GPU) that performs complex rendering calculations, which causes a significant drain on limited battery power in mobile devices.

### SUMMARY

The disclosure provides a method of reducing redundant rendering of frames. In one embodiment, the method includes: (1) receiving draw calls including state information for a frame, (2) generating respective bounding boxes for the draw calls, wherein the bounding box is generated based on vertex data, vertex programs and transformation matrices, (3) comparing the draw calls of the frame to the draw calls of one or more previous frames, (4) identifying draw calls that are not identical in the compared frames, (5) identifying the bounding boxes containing altered regions of the frames based on the draw calls that are not identical in the compared frames and (6) rendering only inside the altered regions.

In another embodiment, a non-transitory computer-readable medium is disclosed. In one embodiment, the non-transitory computer-readable medium is encoded with computer-executable instructions for reducing redundant rendering of frames, wherein the computer-executable instructions when executed cause at least one data processing system to: (1) receive draw calls including state information for a frame, (2) generate respective bounding boxes for the draw calls, wherein the bounding box is generated based on vertex data, vertex programs and transformation matrices, (3) compare the draw calls of the frame to the draw calls of one or more previous frames, (4) identify draw calls that are not identical in the compared frames, (5) identify the bounding boxes containing altered regions of the frames based on the draw calls that are not identical in the compared frames and (6) render inside the altered regions.

In yet another aspect, a graphics rendering system for reducing redundant rendering of frames is disclosed. In one embodiment, the graphics rendering system includes: (1) a graphics processing unit and (2) a memory coupled to the graphics processing unit, wherein the memory contains computer-executable instructions to cause the graphics processing unit to receive draw calls including state information for a frame; generate respective bounding boxes for the draw calls, wherein the bounding box is generated based on vertex data, vertex programs and transformation matrices; compare the draw calls of the frame to the draw calls of one or more previous frames; identify draw calls that are not identical in the compared frames; identify the bounding boxes containing altered regions of the frames based on the draw calls that are not identical in the compared frames; reduce the altered regions into a smaller set of clip rectangles; and render only inside the clip rectangles.

### BRIEF DESCRIPTION

Reference is now made to the following descriptions taken in conjunction with the accompanying drawings, in which:

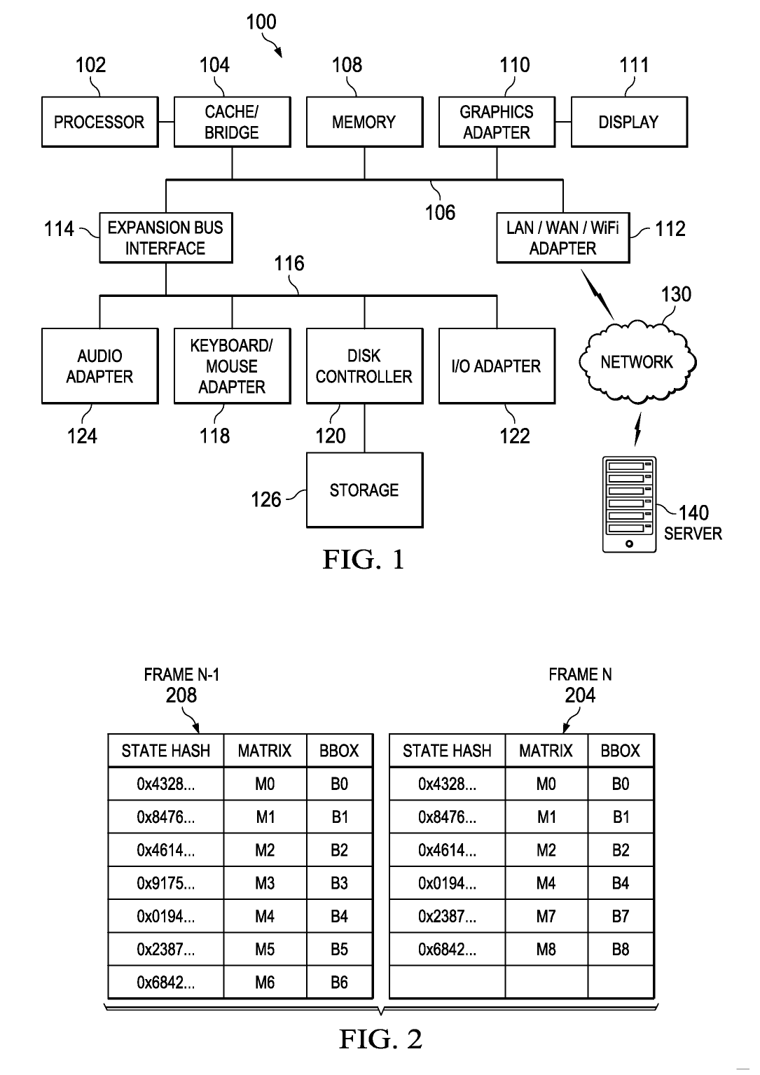

FIG. 1 illustrates a block diagram of a data processing system according to various disclosed embodiments;

FIG. 2 illustrates the comparison of draw calls of two frames;

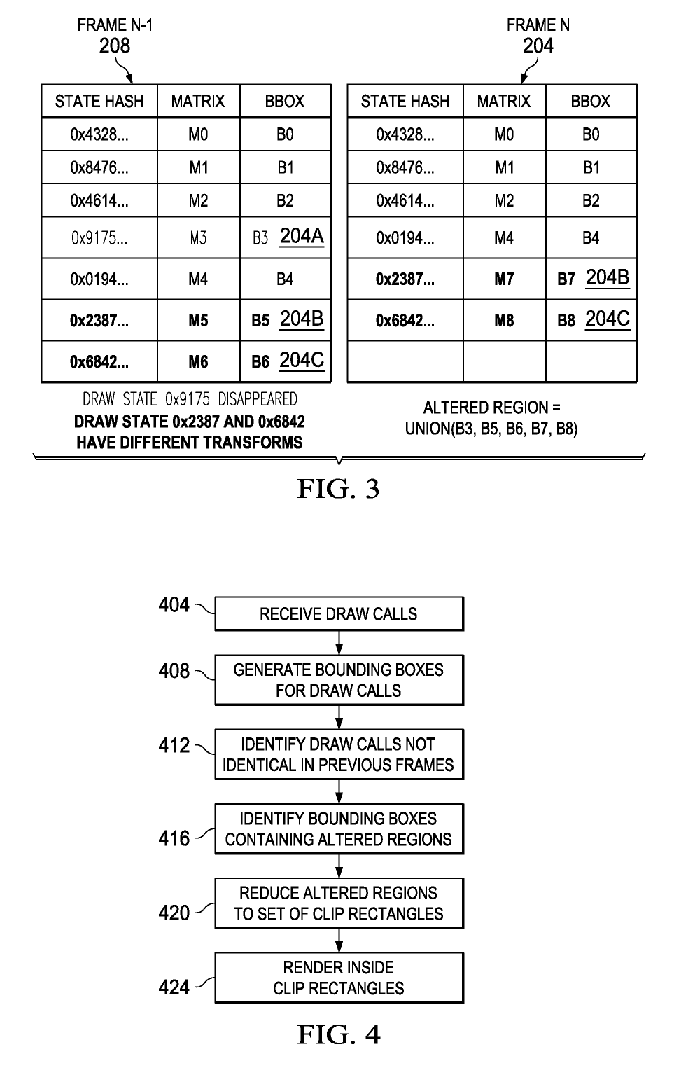

FIG. 3 highlights the draw calls which are not identical in the compared frames;

FIG. 4 is a flow diagram of a method of reducing redundant rendering of frames according to disclosed embodiments;

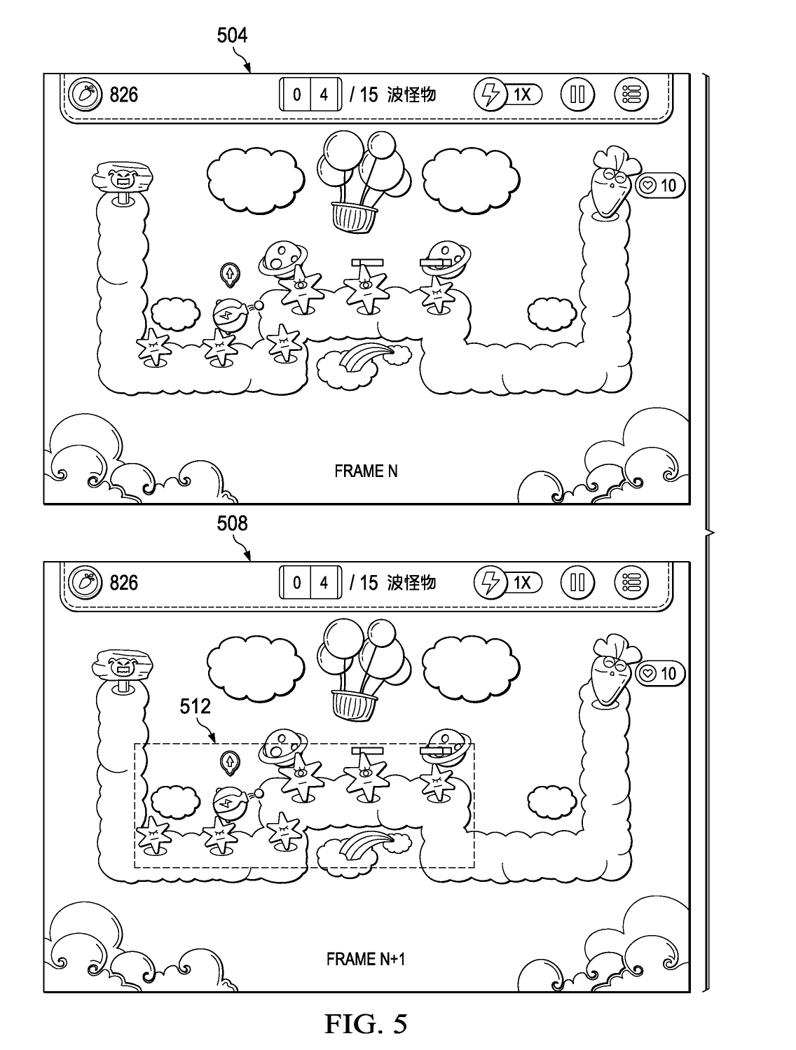

FIG. 5 illustrates two frames; and

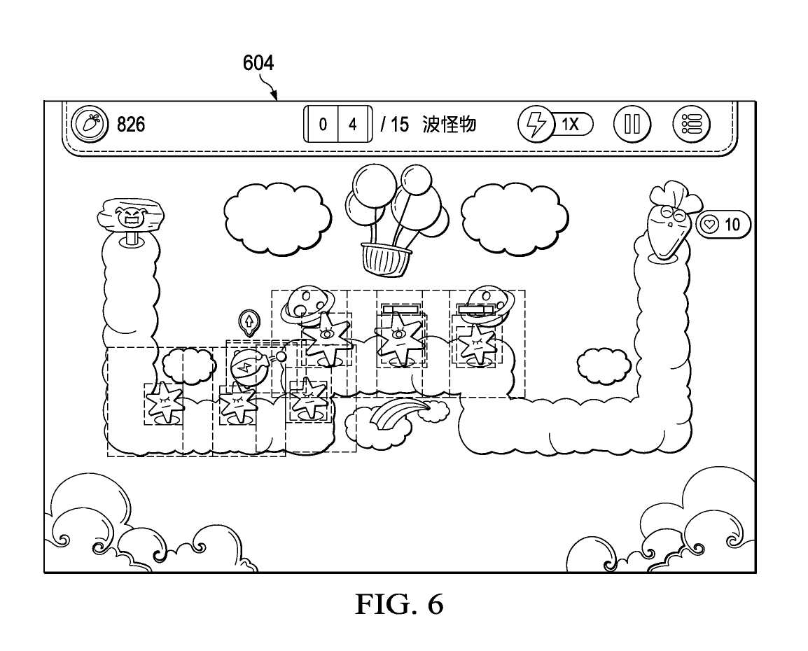

FIG. 6 illustrates clip rectangles.

### DETAILED DESCRIPTION

FIGS. 1-6, discussed below, and the various embodiments used to describe the principles of the present disclosure are by way of illustration only and should not be construed in any way to limit the scope of the disclosure. Those skilled in the art will recognize that the principles of the disclosure may be implemented in any suitably arranged device or a system. For example, a GPU or a graphics processing system can be configured to perform functions described herein. The numerous innovative teachings of the present disclosure will be described with reference to non-limiting embodiments.

Various disclosed embodiments are directed to methods of reducing redundant rendering of frames. According to disclosed embodiments, a frame is compared to one or more previous frames. Based on the comparison, regions of the frame that are not identical to corresponding regions in the previous frames are identified. Thereafter, rendering is performed only on the regions of the frame that are not identical in the previous frames. Thus, rendering is not performed on regions of the frame that are un-altered from the previous frames. By reducing redundant rendering, power consumption by a GPU is reduced.

FIG. 1 depicts a block diagram of data processing system 100 in which an embodiment can be implemented, for example, as a system particularly configured by software, hardware or firmware to perform the processes as described herein, and in particular as each one of a plurality of interconnected and communicating systems as described herein.

Referring to FIG. 1, the data processing system depicted includes processor 102 connected to level two cache/bridge 104, which is connected in turn to local system bus 106. Local system bus 106 may be, for example, a peripheral component interconnect (PCI) architecture bus. Also connected to local system bus in the depicted example are main memory 108 and graphics adapter 110. Graphics adapter 110 may be connected to display 111. The processor 102 may include a central processing unit (CPU) and a graphics processing unit (GPU). The processor 102 can cooperate with the memory 108 to form a graphics rendering system. In one embodiment of a graphics rendering system, the memory is configured to store operating instructions for rendering and the GPU is configured to: receive draw calls including state information for a frame; generate respective bounding boxes for the draw calls, wherein the bounding box is generated based on vertex data, vertex programs and transformation matrices; compare the draw calls of the frame to the draw calls of one or more previous frames; identify draw calls that are not identical in the compared frames; identify the bounding boxes containing altered regions of the frames based on the draw calls that are not identical in the compared frames; reduce the altered regions into a smaller set of clip rectangles; and render only inside the clip rectangles.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to storage 126, which can be any suitable non-transitory machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

Data processing system 100 in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

LAN/ WAN/Wireless adapter 112 can be connected to network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100. Data processing system 100 may be configured as a workstation, and a plurality of similar workstations may be linked via a communication network to form a distributed system in accordance with embodiments of the disclosure.

According to disclosed embodiments, a method of reducing redundant rendering of frames includes receiving draw calls for a frame. The draw calls are analogous to commands which provide coordinates and determine colors of pixels in a rendering surface. The draw calls include state information which control how data is processed in a graphics pipeline. The state information may, for example, include relevant program states (sequences of instructions applied to vertex data or pixel data), vertex data, ROP state (blending, depth testing, and stencil testing modes), and texture state.

According to disclosed embodiments, bounding boxes are generated for the draw calls using vertex data, vertex programs and transformation matrices. A transformation matrix transforms vertex data from one space to another, where a draw call includes matrices (one or more) to transform from object space to screen space.

According to disclosed embodiments, the draw calls of a frame are compared to the draw calls of one or more previous frames. FIG. 2 illustrates the comparison of the draw calls of a frame 204 (Frame N) to a previous frame 208 (Frame N−1). As shown in FIG. 2, the draw calls of each of the frames 204 and 208 include associated state information, matrix values and bounding boxes. Based on the comparison, the draw calls in the frame 204 that are not identical to the corresponding draw calls in the frame 208 are identified. Thus, the draw calls which have changed in the frame 204 are identified.

FIG. 3 highlights the draw calls which are not identical in the frames 204 and 208. Referring to FIG. 3, draw call 204A is present in frame 208 but is missing in frame 204. Also, while draw calls 204B and 204C are present in both frames 204 and 208, they have different transforms. Thus, the draw calls 204B and 204C are not identical in the frames 204 and 208.

According to disclosed embodiments, based on the identification of the draw calls that are not identical in the two frames, bounding boxes in each of the frames 204 and 208 that contain altered regions are identified. Referring again to FIG. 3, bounding boxes B3, B5, B6, B7 and B8 contain the altered regions of the frames.

According to disclosed embodiments, the altered regions are reduced into a smaller or equal number of altered regions, referred to herein as clip rectangles, containing a super-set of pixels contained by the original altered regions. A clip rectangle is defined as a rectangular region of the screen such that only pixels within these rectangles are shaded or written.

According to disclosed embodiments, the altered regions are merged, and a smaller or equal number of clip rectangles are generated. The altered regions are reduced to a smaller or equal number of clip rectangles to enable a graphics processor's clipping functionality to render inside the clip rectangles and discard rendering outside the clip rectangles. If, for example, a graphics processor is capable of rendering 8 inclusive clip rectangles, the altered regions can be merged into 8 clip rectangles so that the graphics processor can render inside the 8 clip rectangles and discard rendering outside the 8 clip rectangles.

By way of example, the first 9 rectangles (i.e., altered regions) may be considered. The two altered regions are identified that cause the least increase in area following a merger. The two identified rectangles are merged, and the unused rectangle is deleted. The process is repeated until there are only 8 clip rectangles remaining, thus allowing a graphics processor to render inside the 8 clip rectangles and discard rendering outside the 8 clip rectangles.

According to disclosed embodiments, prior to rendering a frame, the clip rectangles are loaded in a buffer so that the clips are applied to the frame. Consequently, the static regions, i.e., un-altered regions, of the frame are not rendered, and the previous contents remain unaltered.

According to other disclosed embodiments, a frame can be divided into two sections: a static section of the frame; and a dynamic section of the frame. After rendering the dynamic section of the frame, all other sections are classified as dynamic. Although this coarse classification results in less inclusive bounding boxes, it allows rendering for a frame to proceed without knowledge of the dynamic regions of the frame. Consider, for example, a background image is the only “static” part of the frame, and everything else is dynamic. Thus, the background image can be detected and its bounding rectangle ignored, and everything after that can be considered dynamic. The GPU can accumulate the bounding box for a frame as it renders it, and store it in GPU memory. Or alternately, the GPU can track which pixels need to be rendered in a stencil buffer. So the buffer is filled based on the dynamic rendering in the current and prior frame, and then pixels which need to be drawn are determined.

According to other disclosed embodiments, bounding boxes from previous frames may be reused in the current frame if the vertex data in the current frame is the same as the vertex data in the previous frames although the transformation matrix is different, by adjusting the bounding box according to the difference in transformation matrices. (e.g., if they only differ by a translation, then the bounding box can have the same translation applied).

According to other disclosed embodiments, bounding boxes can be accumulated per-primitive (point, line or triangle) rather than per-vertex in order to skip degenerate primitives (zero-area primitives that don't cover any pixels).

According to other disclosed embodiments, a draw call can be divided into several smaller draw calls to provide a tighter set of altered regions if a part of the original draw call is in fact static. According to disclosed embodiments, multiple bounding boxes may be generated from one draw call. For example, the draw call may be divided into several smaller draw calls and bounding boxes may be generated from the smaller draw calls.

According to other disclosed embodiments, a graphics processing unit (GPU), instead of a central processing unit (CPU), may be utilized to detect altered regions of the frame. For example, bounding boxes from a previous frame may be evaluated using atomics in the GPU. In addition, rather than maintain bounding boxes, dynamic parts of the scene can be rasterized updating a buffer (such as Z, Stencil, or on-chip buffer like Zcull) to mark which altered regions need to be rendered.

According to disclosed embodiments, a frame may be displayed on a screen while another frame is being rendered by double or triple buffering. The pair of frames being compared may be two or three frames apart rather than being adjacent.

According to some disclosed embodiments, rather than redrawing all layers (overlapping blended images) for dynamic regions, a blit (two-dimensional image copy) can be done to copy a check pointed intermediate surface before the dynamic drawing. For scenes with high depth complexity below blended dynamic content, this can reduce bandwidth over drawing all layers. In cases the depth complexity is low or textures are drawn with high magnification, redrawing, rather than doing a blit, can be performed.

FIG. 4 is a flow diagram of a method of reducing redundant rendering of frames according to disclosed embodiments. The method can be performed by a data processing system illustrated in FIG. 1. More specifically, the steps of the method may be performed by a CPU or GPU in the data processing system of FIG. 1.

Referring now to FIG. 4. in block 404, draw calls for a frame are received. The draw calls include state information which defines how data is processed in a graphics pipeline.

In block 408, bounding boxes are generated for the draw calls. The bounding boxes are generated using vertex data, vertex programs and transformation matrices of the draw calls.

In block 412, the draw calls of a frame are compared to the draw calls of one or more previous frames. Based on the comparison, the draw calls in the frame that are not identical to the corresponding draw calls in the previous frames are identified.

In block 416, based on the identification of the draw calls that are not identical in the two frames, bounding boxes in each of the frames that contain altered regions are identified. In block 420, the altered regions are reduced into a smaller or equal number of clip rectangles. A clip rectangle is defined as a rectangular region of the screen such that only pixels within these rectangles are shaded or written. The altered regions are reduced to a smaller or equal number of clip rectangles to enable a graphics processor's clipping functionality to render inside the clip rectangles and discard rendering outside the clip rectangles. In block 424, rendering is performed inside the clip rectangles.

FIG. 5 illustrates two frames 504 (Frame N) and 508 (Frame N+1). The altered region of the frame 508 (Frame N+1) is indicated inside a rectangle 512. FIG. 6 illustrates a frame 604 inside of which clip rectangles are shown.

The disclosure provides various embodiments of methods that reduce redundant rendering of frames. In one embodiment, the method includes receiving draw calls including state information for a frame, and generating respective bounding boxes for the draw calls. The bounding boxes are generated based on vertex data, vertex programs and transformation matrices. The method includes comparing the draw calls of the frame to the draw calls of one or more previous frames, and identifying draw calls that are not identical in the compared frames.

Additionally, the method includes identifying the bounding boxes containing altered regions of the frames based on the draw calls that are not identical in the compared frames. The method further includes reducing the altered regions into a smaller set of clip rectangles and rendering only inside the clip rectangles.

According to disclosed embodiments, a non-transitory computer-readable medium is also provided that is encoded with computer-executable instructions for reducing redundant rendering of frames. The computer-executable instructions when executed cause at least one data processing system to: receive draw calls including state information for a frame; generate respective bounding boxes for the draw calls, wherein the bounding box is generated based on vertex data, vertex programs and transformation matrices; compare the draw calls of the frame to the draw calls of one or more previous frames; identify draw calls that are not identical in the compared frames; identify the bounding boxes containing altered regions of the frames based on the draw calls that are not identical in the compared frames; reduce the altered regions into a smaller set of clip rectangles; and render only inside the clip rectangles. Thus, redundant regions are skipped since the final pixel data is already in a previous frame, and rendering is performed into the same memory as used by the previous frame.

The disclosure also provides embodiments of a graphics rendering system that reduces redundant rendering of frames. The system includes a graphics processing unit and a memory coupled to the graphics processing unit. The memory contains computer-executable instructions to cause the graphics processing unit to: receive draw calls including state information for a frame; generate respective bounding boxes for the draw calls, wherein the bounding box is generated based on vertex data, vertex programs and transformation matrices; compare the draw calls of the frame to the draw calls of one or more previous frames; identify draw calls that are not identical in the compared frames; identify the bounding boxes containing altered regions of the frames based on the draw calls that are not identical in the compared frames; reduce the altered regions into a smaller set of clip rectangles; and render only inside the clip rectangles.

Those skilled in the art will recognize that, for simplicity and clarity, the full structure and operation of all systems suitable for use with the present disclosure is not being depicted or described herein. Instead, only so much of a system as is unique to the present disclosure or necessary for an understanding of the present disclosure is depicted and described. The remainder of the construction and operation of the disclosed systems may conform to any of the various current implementations and practices known in the art.

Of course, those of skill in the art will recognize that, unless specifically indicated or required by the sequence of operations, certain steps in the processes described above may be omitted, performed concurrently or sequentially, or performed in a different order. Further, no component, element, or process should be considered essential to any specific claimed embodiment, and each of the components, elements, or processes can be combined in still other embodiments.

It is important to note that while the disclosure includes a description in the context of a fully functional system, those skilled in the art will appreciate that at least portions of the mechanism of the present disclosure are capable of being distributed in the form of instructions contained within a non-transitory machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Those skilled in the art to which this application relates will appreciate that other and further additions, deletions, substitutions and modifications may be made to the described embodiments.

What is claimed is:

1. A method of reducing redundant rendering of frames, comprising:
receiving draw calls including state information for a frame;
generating respective bounding boxes for the draw calls, wherein the bounding boxes are generated based on vertex data, vertex programs and transformation matrices;
comparing the draw calls of the frame to the draw calls of one or more previous frames;
identifying draw calls that are not identical in the compared frames;
identifying the bounding boxes containing altered regions of the frames based on the draw calls that are not identical in the compared frames; and
rendering only inside the altered regions.

2. The method of claim 1, further comprising:
reducing the altered regions into a smaller or equal number of clip rectangles; and
rendering inside the clip rectangles.

3. The method of claim 2, further comprising disabling rendering outside the clip rectangles.

4. The method of claim 1, wherein the altered regions are merged to generate a smaller set of clip rectangles.

5. The method of claim 2, wherein each of the clip rectangles is a rectangular region such that only pixels within the rectangular region are written.

6. The method of claim 1, wherein the transformation matrices transform vertex data from an object space into a screen space.

7. The method of claim 1, wherein comparing the draw calls include hashing the state information and the vertex data and comparing the hashes.

8. The method of claim 1, wherein a graphics processing unit constructs the bounding boxes while rendering a frame.

9. The method of claim 1, wherein the bounding boxes of a previous frame are reused if the vertex data, vertex programs, and transformation matrices are unchanged.

10. The method of claim 1, wherein the bounding boxes are re-calculated from bounding boxes of a previous frame if only the transformation matrices have changed.

11. The method of claim 1, wherein multiple of the bounding boxes are generated from each draw call.

12. A non-transitory computer-readable medium encoded with computer-executable instructions for reducing redundant rendering of frames, wherein the computer-executable instructions when executed cause at least one data processing system to:
receive draw calls including state information for a frame;
generate respective bounding boxes for the draw calls, wherein the bounding box is generated based on vertex data, vertex programs and transformation matrices;
compare the draw calls of the frame to the draw calls of one or more previous frames;
identify draw calls that are not identical in the compared frames;
identify the bounding boxes containing altered regions of the frames based on the draw calls that are not identical in the compared frames; and
render inside the altered regions.

13. The non-transitory computer-readable medium of claim 12, wherein the altered regions are reduced into a smaller set of clip rectangles, and rendering is performed inside the clip rectangles.

14. The non-transitory computer-readable medium of claim 12, wherein rendering is disabled outside the clip rectangles.

15. The non-transitory computer-readable medium of claim 13, wherein the altered regions are merged to generate the smaller set of clip rectangles.

16. A graphics rendering system for reducing redundant rendering of frames, comprising:
a graphics processing unit; and
a memory coupled to the graphics processing unit, wherein the memory contains computer-executable instructions to cause the graphics processing unit to:
receive draw calls including state information for a frame;
generate respective bounding boxes for the draw calls, wherein a bounding box is generated based on vertex data, vertex programs and transformation matrices;
compare the draw calls of the frame to the draw calls of one or more previous frames;
identify draw calls that are not identical in the compared frames;
identify the bounding boxes containing altered regions of the frames based on the draw calls that are not identical in the compared frames;
reduce the altered regions into a smaller set of clip rectangles; and
render only inside the clip rectangles.

17. The graphics processing system of claim 16 wherein the graphics processing unit merges the altered regions to generate the smaller set of clip rectangles.

18. The graphics processing system of claim 16 wherein the graphics processing unit compares the draw calls by hashing the state information and the vertex data and comparing the hashes.

19. The graphics processing system of claim 16 wherein the graphics processing unit constructs the bounding boxes while rendering a frame.

20. The graphics processing system of claim 16 wherein the graphics processing unit reuses the bounding boxes of a previous frame if the vertex data, program, and transformation matrices are unchanged.
